(19) United States
(12) Patent Application Publication
(10) Pub. No.: US 2026/0065657 A1
(43) Pub. Date: Mar. 5, 2026

(54) MACHINE LEARNING GENERATED LISTING

(71) Applicant: eBay Inc., San Jose, CA (US)

(72) Inventors: Yogesh Patil, Davis, CA (US); Harish Moodalbail Ganeshmurthy, Hayward, CA (US)

(21) Appl. No.: 18/822,890

(22) Filed: Sep. 3, 2024

(51) Int. Cl. G06V 10/82

(52) U.S. Cl. CPC G06V 10/82

(57) ABSTRACT

A system and method for generating a listing is described. A computer-implemented method includes detecting, at a photo application native to an operating system of a mobile device, a selection of one or more images generated with a camera of the mobile device, detecting a selection of a client publication application installed on the mobile device using a user interface of the photo application, in response to detecting the selection of the client publication application, identifying characteristics of an item depicted in the one or more images, and generating one or more listings based on the characteristics of the item depicted in the one or more images.

### TECHNICAL FIELD

The subject matter disclosed herein generally relates to generating a listing for an online publication system. More specifically, the present application pertains to methods and systems for generating listings using a native operating system of a mobile device and machine learning techniques for an efficient listing creation process.

### BACKGROUND

The traditional process of generating listings for publication platforms involves multiple operations on a computing device: first, an application is used to capture pictures. Then, another application is used to retrieve the pictures from the first application. Finally, a third application is used to receive product details input from a user and upload multiple images for each item. This process can be inefficient for the computing device, especially when dealing with multiple items and pictures. There is a need for solutions that can leverage the capabilities of mobile devices and machine learning technologies to create a more efficient approach to generating listings, particularly with high volumes of items and pictures.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some example embodiments.

FIG. 2 is a block diagram illustrating a publication system that, in one example embodiment, is provided as part of a networked system.

FIG. 3 is a block diagram illustrating a machine learning generated listing system in accordance with one example embodiment.

FIG. 4 is a block diagram an example operation of the programmatic client and the machine learning generated listing system in accordance with one example embodiment.

FIG. 5 illustrates a method for generating a listing in accordance with one example embodiment.

FIG. 6 illustrates a method for generating a listing in accordance with one example embodiment.

FIG. 7 illustrates a method for generating a listing in accordance with one example embodiment.

FIG. 8 illustrates a graphical user interface of a native photo application in accordance with one example embodiment.

FIG. 9 illustrates a graphical user interface of grouping options in accordance with one example embodiment.

FIG. 10 illustrates a graphical user interface of a continuous listing mode in accordance with one example embodiment.

FIG. 11 illustrates a flow process in accordance with one example embodiment.

FIG. 12 illustrates a flow process for a machine learning generated listing in accordance with one example embodiment.

FIG. 13 illustrates a flow process for a machine learning generated listing with a group ratio in accordance with one example embodiment.

FIG. 14 illustrates a flow process for a machine learning generated listing with a group ratio in accordance with another example embodiment.

FIG. 15 is a diagrammatic representation of a machine in the form of a computer system within which a set of instructions may be executed for causing the machine to perform any one or more of the methodologies discussed herein, according to an example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

The present application describes a system for generating listings for a publication platform using mobile devices and machine learning technologies. In a first example embodiment, a method for creating listings directly from a mobile device's native photo application (e.g., photo album) is described. A user of the mobile device selects photos from their device's native photo application to the publication application, which then uses machine learning (ML) to automatically generate listing content. The first example embodiment allows for seamless integration between the device's native photo-sharing capabilities and the publication application.

In the first example embodiment, the native photo application is configured to share images with the publication application. The publication application is also configured to accept shared images from the native photo application. The publication application initiates a background process that uses machine learning to analyze the images and generate listing content automatically. This process includes creating titles, descriptions, and other relevant listing details based on the shared photos. In another example embodiment, the publication application on the mobile device pushes the images to a server-based publication system that analyzes the images using machine learning and generates listing content automatically.

In a second example embodiment, a method for generating multiple listings using a continuous listing model of the publication application is described. The continuous listing mode enables the user of the mobile device to take photos continuously while the publication application processes the photos in the background to automatically create listings. The second embodiment generates multiple listings simultaneously as photos are being taken, significantly reducing the mobile device's operations for bulk listing creation.

In the second example embodiment, the publication application on the mobile device processes these photos in real-time, groups them into predefined sets (e.g., 12 photos per listing), and initiates the ML-based listing generation process for each set. This allows for simultaneous photo capture and listing creation, with the option for a separate person to review and refine the generated listings in parallel.

In a third example embodiment, a method for generating listings with grouping options is described. The grouping options indicate image-to-listing ratios and specify how many photos to use per listing. Example grouping options can specify one photo per listing, two photos per listing, or custom groupings. This added grouping control enables users of the mobile device to tailor the listing process to their specific needs and preferences.

In one example embodiment, a computer-implemented method includes detecting, at a photo application native to an operating system of a mobile device, a selection of one or more images generated with a camera of the mobile device, detecting a selection of a client publication application installed on the mobile device using a user interface of the photo application, in response to detecting the selection of the client publication application, identifying characteristics of an item depicted in the one or more images, and generating one or more listings based on the characteristics of the item depicted in the one or more images.

In another example embodiment, the computer-implemented method also includes identifying a group listing setting in the client publication application, the group listing setting indicating a number of images per listing, where each group of a plurality of groups of images includes the number of images, and generating a plurality of listings for the plurality of groups of images based on the number of images per listing, where each listing of the plurality of listings corresponds to an item depicted in a corresponding group of images from the one or more images. Other technical features may be readily apparent to one skilled in the art from the following figures, descriptions, and claims.

In another example embodiment, the computer-implemented method also includes identifying a continuous listing setting in the client publication application, the continuous listing setting indicating a default number of images per listing, accessing continuously captured images with the client publication application, segmenting the continuously captured images to group images corresponding to individual items depicted in the continuously captured images based on the default number of images per listing, and generating separate listing drafts for each group of images corresponding to different items, where each listing draft is populated with listing data generated based on the characteristics identified from the respective group of images. Other technical features may be readily apparent to one skilled in the art from the following figures, descriptions, and claims.

As a result, one or more of the methodologies described herein facilitate solving the technical problem of accurately generating listings based on the characteristics of items depicted in images taken from a native photo application of a mobile device. The present platform enables seamless integration between the native photo application and the publication application on the mobile device. As such, one or more of the methodologies described herein may obviate a need for certain efforts or computing resources that otherwise would be involved in client devices switching between a photo album of the native photo application and the publication application, particularly with large volumes of photos and items. As a result, resources used by one or more machines, databases, or devices (e.g., within the environment) may be reduced. Examples of such computing resources include processor cycles, network traffic, memory usage, data storage capacity, power consumption, network bandwidth, and cooling capacity.

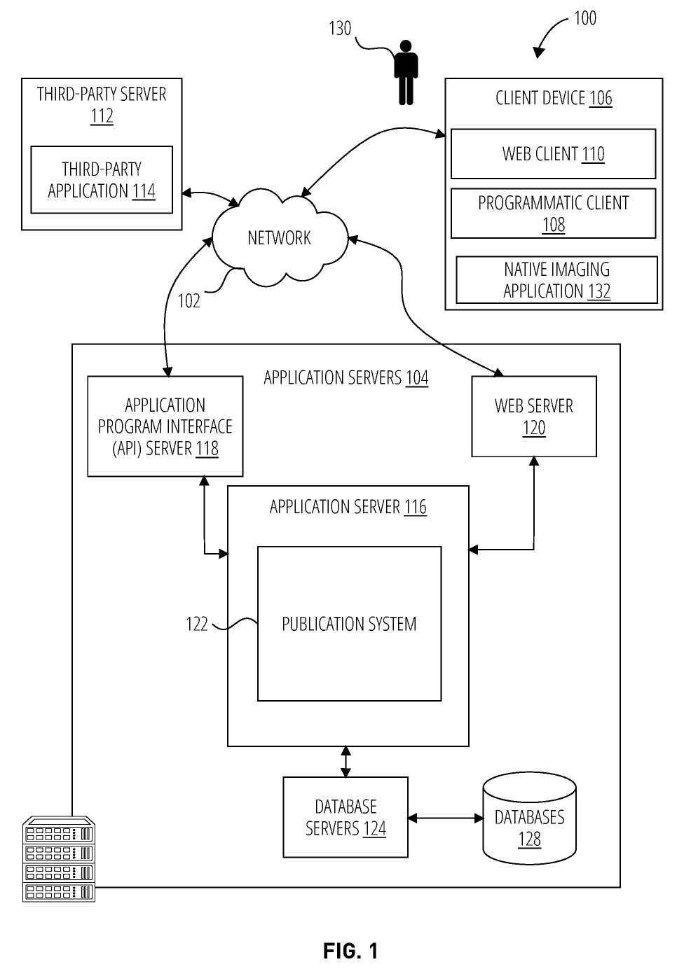

FIG. 1 is a diagrammatic representation of a network environment 100 in which some example embodiments of the present disclosure may be implemented or deployed. One or more application servers 104 provide server-side functionality via a network 102 to a networked user device, in the form of a client device 106. The client device 106 may also be referred to as a mobile device. The client device 106 hosts and executes a web client 110 (e.g., a browser), a programmatic client 108 (e.g., an “app”), and a native imaging application 132.

An Application Program Interface (API) server 118 and a web server 120 provide respective programmatic and web interfaces to application servers 104. A specific application server 116 hosts a publication system 122, which includes components, modules and/or applications.

The publication system 122 may refer to an online publication platform. Examples of online publication platforms include but are not limited to, e-commerce platforms and social media platforms. In one example, the publication system 122 includes an e-commerce platform that provides a number of marketplace functions and services to users who access the application servers 104. In one example embodiment, the publication system 122 enables users (e.g., user 130) to author and manage listings (e.g., publication listings for the publication system 122) on the network environment 100. In another example embodiment, the publication system 122 receives a photo from the client device 106, analyzes the photo using a machine learning model to determine characteristics (e.g., type, brand, color, model) of an item depicted in the photo, and generates a listing based on the characteristics.

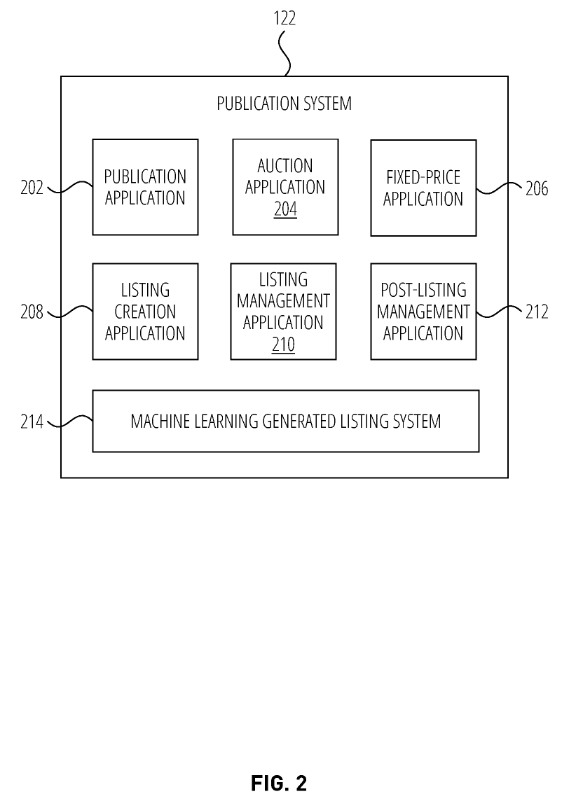

Further, while the network environment 100 shown in FIG. 1 employs a client-server architecture, the embodiments are, of course, not limited to such an architecture, and could equally well find application in a distributed, or peer-to-peer, architecture system, for example. Features of the publication system 122 could also be implemented as standalone software programs, which do not necessarily have networking capabilities. In another example, a machine learning analysis may be performed at the publication system 122, at the programmatic client 108, or at another system (e.g., third-party server 112). The publication system 122 is described in more detail below with respect to FIG. 2.

The web client 110 accesses the various publication system 122 via the web interface supported by the web server 120. Similarly, the programmatic client 108 accesses the various services and functions provided by the publication system 122 via the programmatic interface provided by the Application Program Interface (API) server 118. The programmatic client 108 may, for example, be a seller application (e.g., eBay Application developed by eBay Inc., of San Jose, California) to enable the user 130 to take pictures of items, author, and manage listings on the network environment 100 in an offline manner, and to perform batch-mode communications between the programmatic client 108 and the application servers 104.

In another example embodiment, the programmatic client 108 integrates or communicates with a native imaging application 132 (e.g., a photo album application/photo capture application that is native to an operating system of the client device 106). In other words, the native imaging application 132 is not a third-party application to an operating system of the client device 106. The client device 106 is not limited to a mobile device such as a smartphone or a computing tablet. The client device 106 can be any computing device that supports sharing a photo to an application operating at the client device 106. Examples include a Mac photo sharing to a Mac application, Windows PC sharing to a Windows application, and an IOT device sharing a captured photo to an API interface. In other examples, such functionalities can also be implemented using emulators to achieve the same usage (e.g., iOS device emulator or Android device emulator).

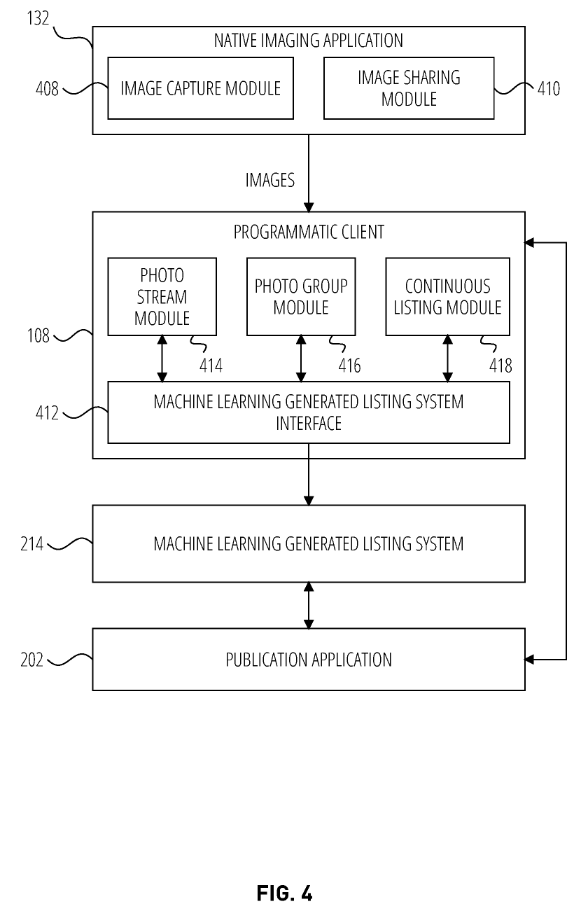

In another example embodiment, the native imaging application 132 receives the photo from the native (or outside third party) operating system of the client device 106. The native imaging application 132 can receive such resources based on a privacy agreement between the user and the third-party system it uses. In other examples, the native imaging application 132 can operate offline and does not need any Internet connection for this interface by caching the image until the Internet connection is available to complete the rest of the tasks. The programmatic client 108 and native imaging application 132 are described in more detail below with respect to FIG. 4.

FIG. 1 also illustrates a third-party application 114 executing on a third-party server 112 as having programmatic access to the application servers 104 via the programmatic interface provided by the Application Program Interface (API) server 118. For example, the third-party application 114 may, utilizing information retrieved from the application server 116, support one or more features or functions on a website hosted by a third party. The third-party website may, for example, provide one or more ML analysis, promotional, marketplace, or payment functions that are supported by the relevant applications of the application servers 104.

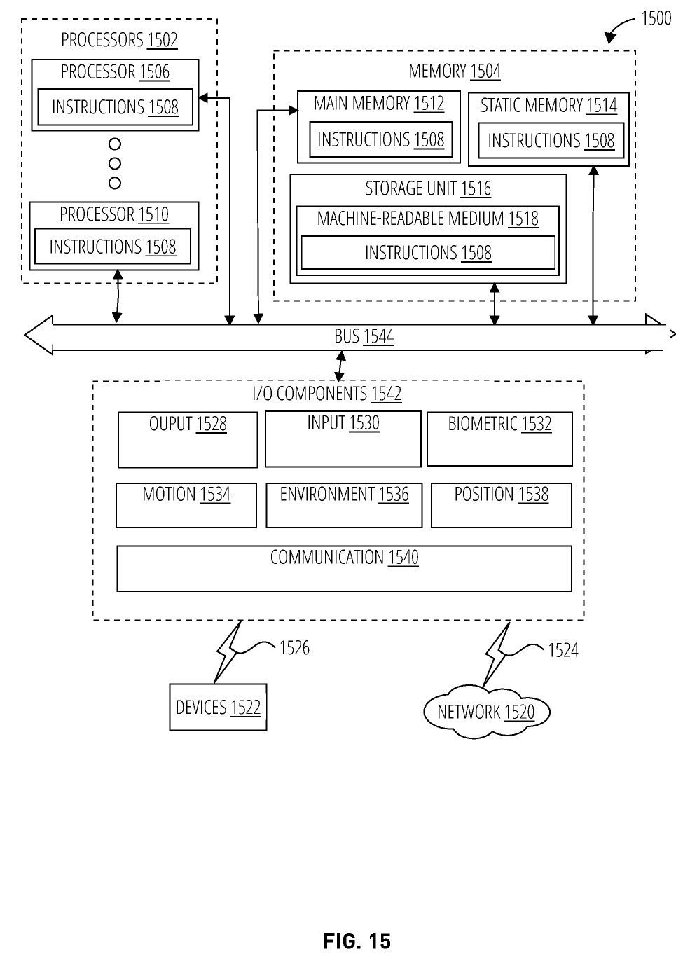

Any of the systems or machines (e.g., databases, devices, servers) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 15, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems or machines illustrated in FIG. 1 may be combined into a single system or machine, and the functions described herein for any single system or machine may be subdivided among multiple systems or machines. Additionally, any number and types of client device 106 may be embodied within the network environment 100. Furthermore, some components or functions of the network environment 100 may be combined or located elsewhere in the network environment 100. For example, some of the functions of the client device 106 may be embodied at the application server 116.

FIG. 2 is a block diagram illustrating the publication system 122 that, in one example embodiment, are provided as part of the network environment 100. The publication system 122 may be hosted on dedicated or shared server machines (not shown) that are communicatively coupled to enable communications between or among server machines. The publication system 122 themselves are communicatively coupled (e.g., via appropriate interfaces) to each other and to various data sources, so as to allow information to be passed between or among the publication system 122 or so as to allow the publication system 122 to share and access common data. The publication system 122 may furthermore access one or more databases 128 via the database servers 124.

The publication system 122 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the publication system 122 is shown to include a publication application 202, an auction application 204, a fixed-price application 206, a listing creation application 208, a listing management application 210, a post-listing management application 212, and a machine learning generated listing system 214.

The publication application 202 includes, for example, an e-commerce platform or a social media platform. The publication application 202 describes a system that integrates the functionality of sharing photos and content across multiple platforms while leveraging machine learning capabilities for automated listing generation. The publication application 202 details how users can select photos from their device's native photo app and share them not only to e-commerce platforms for listing creation but also to various social media platforms for broader content distribution.

In another example, this integrated approach allows user 130 to seamlessly generate product listings on e-commerce platforms while simultaneously sharing product images on social media, potentially leveraging the same AI/ML technologies to generate appropriate captions or descriptions for each platform. The publication application 202 can adapt to different platform requirements, such as image grouping preferences or character limits, ensuring optimal content presentation across diverse digital ecosystems.

The auction application 204 support auction-format listing and price setting mechanisms (e.g., English, Dutch, Vickrey, Chinese, Double, Reverse auctions, etc.). The various auction application 204 may also provide a number of features in support of such auction-format listings, such as a reserve price feature whereby a seller may specify a reserve price in connection with a listing and a proxy-bidding feature whereby a bidder may invoke automated proxy bidding.

The fixed-price application 206 supports fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, California) may be offered in conjunction with auction-format listings and allow a buyer to purchase goods or services, which are also being offered for sale via an auction, for a fixed price that is typically higher than the starting price of the auction.

The listing creation application 208 allows sellers to conveniently authorize listings pertaining to goods or services that they wish to transact via the application servers 104. In another example, the publication application 202 includes features for automatically generating listings from listing creation application 208. In another example, the listing creation application 208 receives metadata or attribute values for an item depicted in a photo taken with the client device 106, and generates a draft listing for the publication application 202 based on the metadata and attribute values.

The listing management application 210 allows sellers to manage such listings. Specifically, where a particular seller has authored and/or published a large number of listings, the management of such listings may present a challenge.

The listing management application 210 provides a number of features (e.g., auto-relisting, inventory level monitors, etc.) to assist the seller in managing such listings. The post-listing management application 212 also assists sellers with a number of activities that typically occur post-listing.

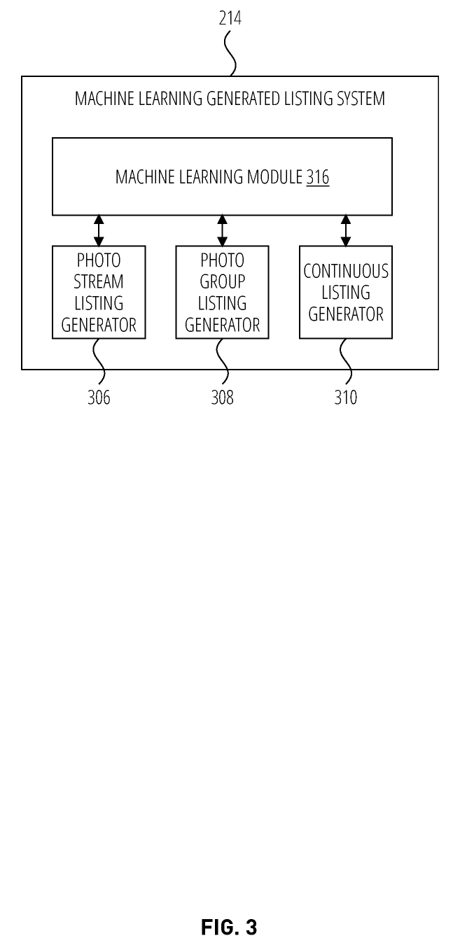

A machine learning generated listing system 214 enables automatically generating listings based on photos shared from the client device 106. For example, the machine learning generated listing system 214 automates and enhances the process of creating merchandise listings for e-commerce platforms. The machine learning generated listing system 214 leveraging artificial intelligence and machine learning algorithms to analyze images uploaded by the client device 106, extract relevant item characteristics, and generate comprehensive listing content. This machine learning generated listing system 214 seamlessly integrates with various input methods, including photo streams from mobile devices, grouped photo selections, and continuous photo capture, to accommodate different seller needs and preferences. One of the advantage of the machine learning generated listing system 214 is significantly increasing efficient operations of the client device 106 to generate high-quality listings, improving listing accuracy through AI-powered content generation by streamlining the listing process, particularly for processing large volumes of items. The machine learning generated listing system 214 is described in more detail below with respect to FIG. 3.

It should be noted that the term "web browser" as used in this disclosure shall be interpreted broadly to cover any application capable of displaying item attributes and rendering images from a web server. As such, this may include traditional web browsers as well as stand-alone applications (or apps) operating on mobile or other devices. For example, the web browser could be a traditional web browser such as Internet Explorer from Microsoft Corp., a stand-alone app such as a shopping application, a video player app, etc.

In another example where the web browser is a stand-alone app, it may be operating on, for example, a mobile device having a display and a camera. The techniques described herein could, therefore, be applied to an image obtained by the mobile device from an outside source, such as via the Internet, an image previously stored on the mobile device, or an image taken by the camera on the mobile device, potentially in real-time. Indeed, the techniques described herein can be applied to any device that is capable of obtaining a digital image and transmitting portions of that digital image to another device. Mobile devices are certainly one example, but others are possible as well, such as wearables and head-mounted devices.

FIG. 3 is a block diagram illustrating the machine learning generated listing system 214 in accordance with one example embodiment. The machine learning generated listing system 214 includes a machine learning module 316, a photo stream listing generator 306, a photo group listing generator 308, and a continuous listing generator 310.

The machine learning module 316 employs artificial intelligence and machine learning algorithms to analyze images, identify item characteristics, and use the item characteristics to populate entry fields for an automatically generated draft listing. In one example, the machine learning module 316 applies computer vision techniques to the photos/images to recognize objects, assess quality, and extract key features from the shared images. In one example, the machine learning module 316 can operate on a combination of the application server 116, the third-party server 112, or the client device 106.

The photo stream listing generator 306 handles the processing of images shared directly from the client device 106's native photo application. For example, the photo stream listing generator 306 interfaces with the mobile device's photo-sharing capabilities, allowing users to select and send images to the e-commerce platform (e.g., publication system 122) for listing creation and publication. In one example, the client device 106 executes the native imaging application 132. The client device 106 presents a photo album of the native imaging application 132. The native imaging application 132 provides an option to share a selected image from the photo album with the publication system 122.

The photo group listing generator 308 manages the grouping of multiple images for listing creation. In one example, the photo group listing generator 308 generates a graphical user interface for the user 130 to select the number of images/photos per listing and provide flexibility in how listings are created from a batch of photos. In another example, the photo group listing generator 308 directs the machine learning module 316 and the publication application 202 to process preset options (e.g., 1, 2, 12, or 40 photos per listing) or custom groupings defined by the user 130.

The continuous listing generator 310 enables a continuous listing mode where the user 130 continuously takes pictures using the client device 106. The client device 106's camera captures photos in real-time, groups them into predefined sets (according to a user-selected/default configuration setting), and initiates the listing generation process for each set as photos are taken. For example, the continuous listing generator 310 receives a stream of pictures from the client device 106. The continuous listing generator 310 groups the pictures based on the number of pictures per group setting. The continuous listing generator 310 then sends the set of pictures for a corresponding group to the machine learning module 316 for analysis.

FIG. 4 is a block diagram showing the operation of the programmatic client 108 and the machine learning generated listing system 214 in accordance with one example embodiment. The native imaging application 132 includes an image capture module 408 and an image sharing module 410. The image capture module 408 enables the user 130 to capture an image using an optical sensor of the client device 106. The image sharing module 410 allows the user 130 to share selected photos with selected third-party applications 114 from within the native imaging application 132. For example, the native imaging application 132 presents photos in a photo album of the native imaging application 132 at the client device 106. The user 130 selects one or more photos within the native imaging application 132 to share with a third-party application. The third-party application is not native to the operating system. The third-party application can be an application operating on the client device 106 or outside the client device 106 (e.g., on publication application 202). After the user 130 confirms sharing the selected images from the photo album with one of the selected applications (e.g., programmatic client 108), the selected photos are provided to the programmatic client 108 (or to publication application 202 if selected).

The programmatic client 108 includes a machine learning generated listing system interface 412, a photo stream module 414, a photo group module 416, and a continuous listing module 418. The programmatic client 108 includes a client-side publication application that communicates with publication system 122.

In one example, the programmatic client 108 accesses a shared photo via the photo stream module 414 and sends the shared photo for analysis to machine learning generated listing system 214 via the machine learning generated listing system interface 412. In one example, the photo stream module 414 communicates with the image sharing module 410 to seamlessly integrate with the native imaging application 132. In other words, the user 130 does not need to switch between a photo album displayed with the native imaging application 132 and the programmatic client 108.

The photo group module 416 manages the grouping of multiple images for listing creation. In one example, the photo group listing generator 308 generates a graphical user interface for the user 130 to select the number of images/photos per listing and provide flexibility in how listings are created from a batch of photos. In another example, the photo group module 416 directs a combination of the machine learning generated listing system interface 412, the machine learning generated listing system 214, and the publication application 202 to process preset options (e.g., 1, 2, 12, or 40 photos per listing) or custom groupings defined by the user 130.

The continuous listing module 418 enables a continuous listing mode where the user 130 continuously takes pictures using the client device 106 (e.g., via the native imaging application 132 or the programmatic client 108). The client device 106's camera captures photos in real-time, groups them into predefined sets (according to a user-selected/default configuration setting), and initiates the listing generation process for each set as photos are taken. For example, the continuous listing module 418 accesses a stream of pictures taken at the client device 106. The continuous listing module 418 groups the pictures based on the number of pictures per group setting. The continuous listing module 418 then sends the set of pictures for a corresponding group to the machine learning generated listing system 214 for analysis.

The continuous listing module 418 does not depend on the native imaging application 132. Instead, it uses device components such as the device camera. In this scenario, privacy is established directly between the user and the third-party app. These resources are not shared back to the native imaging application 132 or any other third-party application unless specific interfaces are exposed with proper validation. For instance, internet access is used implicitly to provide real-time feedback during continuous photo sessions and for offline synced listing post-processing.

The machine learning generated listing system 214 automatically generates draft listings for each item or for each group based on the settings in photo stream module 414, photo group module 416, or continuous listing module 418. For example, the machine learning generated listing system 214 automatically populates entry fields of a listing based on the characteristics of an item identified in a picture or a group of pictures. In another example, the machine learning generated listing system 214 generates a draft listing for the user 130 to review. Once the user 130 approves the draft listing, the publication application 202 publishes the approved listing.

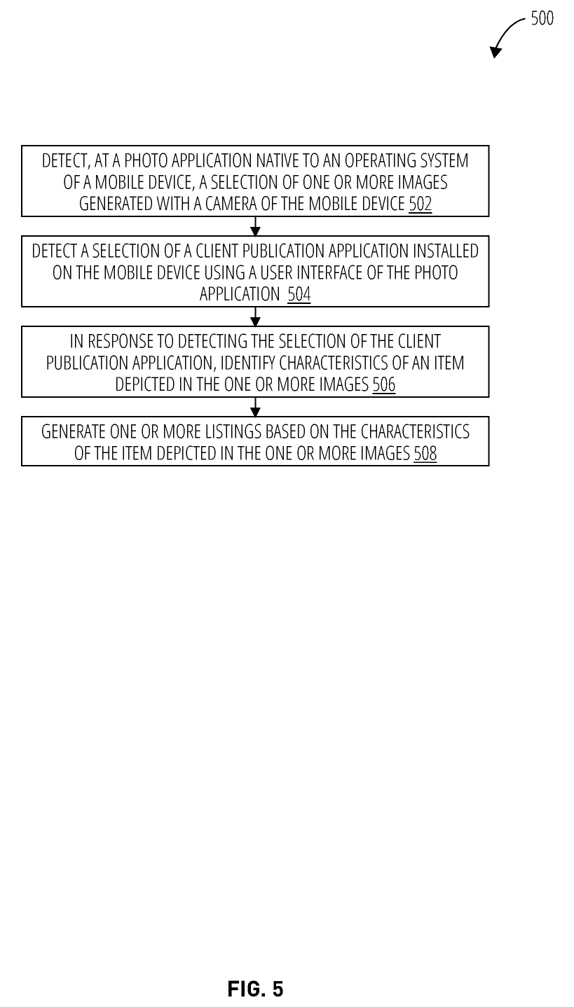

FIG. 5 illustrates a method for generating a listing (e.g., routine 500) in accordance with one example embodiment. Although the example routine 500 depicts a particular sequence of operations, the sequence may be altered without departing from the scope of the present disclosure. For example, some of the operations depicted may be performed in parallel or in a different sequence that does not materially affect the function of the routine 500. In other examples, different components of an example device or system that implements the routine 500 may perform functions at substantially the same time or in a specific sequence.

According to some examples, the method includes detecting, at a photo application native to an operating system of a mobile device, a selection of one or more images generated with a camera of the mobile device at block 502. Operations at block 502 can be performed with the native imaging application 132.

According to some examples, the method includes detecting a selection of a client publication application installed on the mobile device using a user interface of the photo application at block 504. Operations at block 504 can be performed with the native imaging application 132.

According to some examples, the method includes, in response to detecting the selection of the client publication application, identifying characteristics of an item depicted in one or more images at block 506. Operations at block 506 can be performed with photo stream module 414, machine learning generated listing system interface 412, and/or machine learning generated listing system 214.

According to some examples, the method includes generating one or more listings based on the characteristics of the item depicted in one or more images at block 508. Operations at block 508 can be performed with the machine learning generated listing system 214 and/or publication application 202.

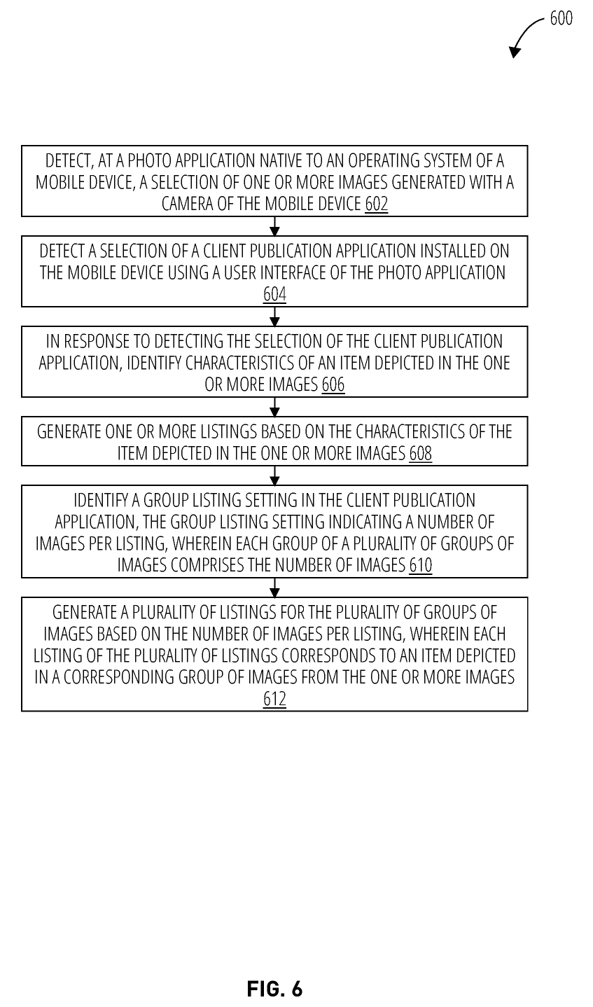

FIG. 6 illustrates an example routine 600 for generating a listing (e.g., routine 600). Although the example routine 600 depicts a particular sequence of operations, the sequence may be altered without departing from the scope of the present disclosure. For example, some of the operations depicted may be performed in parallel or in a different sequence that does not materially affect the function of the routine 600. In other examples, different components of an example device or system that implements the routine 600 may perform functions at substantially the same time or in a specific sequence.

According to some examples, the method includes detecting, at a photo application native to an operating system of a mobile device, a selection of one or more images generated with a camera of the mobile device at block 602. Operations at block 602 can be performed with the native imaging application 132.

According to some examples, the method includes detecting a selection of a client publication application installed on the mobile device using a user interface of the photo application at block 604. Operations at block 604 can be performed with the native imaging application 132.

According to some examples, the method includes, in response to detecting the selection of the client publication application, identifying characteristics of an item depicted in one or more images at block 606. Operations at block 606 can be performed with photo stream module 414, machine learning generated listing system interface 412, and/or machine learning generated listing system 214.

According to some examples, the method includes generating one or more listings based on the characteristics of the item depicted in one or more images at block 608. Operations at block 608 can be performed with the machine learning generated listing system 214 and/or publication application 202.

According to some examples, the method includes identifying a group listing setting in the client publication application, the group listing setting indicating a number of images per listing, wherein each group of a plurality of groups of images comprises the number of images at block 610. Operations at block 610 can be performed using the photo group module 416.

According to some examples, the method includes generating a plurality of listings for the plurality of groups of images based on the number of images per listing, wherein each listing of the plurality of listings corresponds to an item depicted in a corresponding group of images from the one or more images at block 612. Operations at block 612 can be performed using the photo group module 416, the machine learning generated listing system 214, and/or the publication application 202.

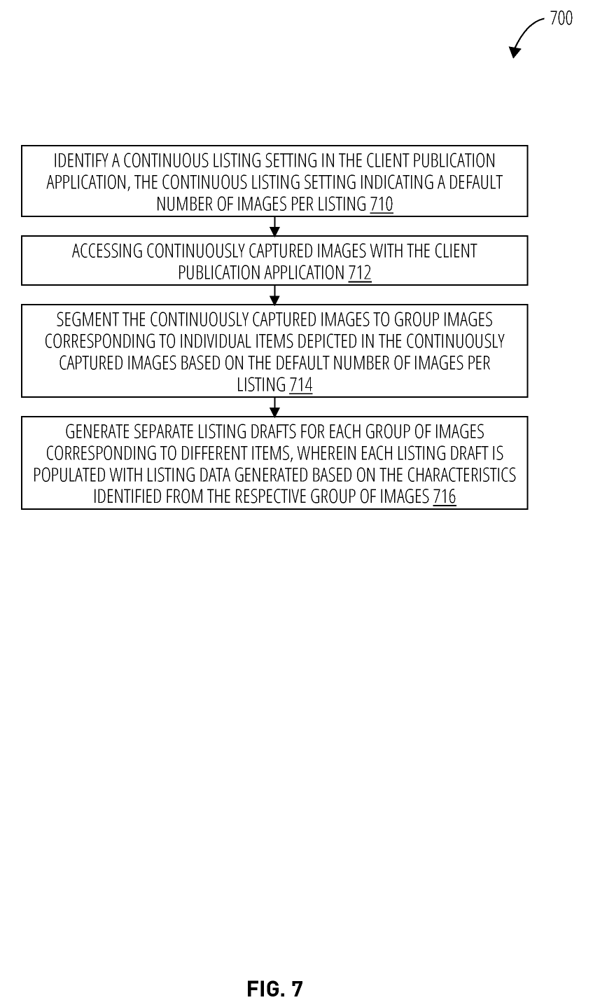

FIG. 7 illustrates an example routine 700 for generating a listing (e.g., routine 700). Although the example routine 700 depicts a particular sequence of operations, the sequence may be altered without departing from the scope of the present disclosure. For example, some of the operations depicted may be performed in parallel or in a different sequence that does not materially affect the function of the routine 700. In other examples, different components of an example device or system that implements the routine 700 may perform functions at substantially the same time or in a specific sequence.

According to some examples, the method includes identifying a continuous listing setting in the client publication application 820 and the continuous listing setting indicating a default number of images per listing at block 710. Operations at block 710 can be performed using the continuous listing module 418.

According to some examples, the method includes accessing continuously captured images with the client publication application 820 at block 712. Operations at block 712 can be performed using the continuous listing module 418.

According to some examples, the method includes segmenting the continuously captured images to group images corresponding to individual items depicted in the continuously captured images based on the default number of images per listing at block 714. Operations at block 714 can be performed using the continuous listing module 418.

Here is the rewritten text for clarity and improved grammar: According to some examples, the method involves creating separate listing drafts for each group of images corresponding to different items. Each listing draft is filled with listing data generated based on the characteristics identified from the respective group of images at block 716. Operations at block 716 can be carried out using the machine learning-generated listing system 214.

In one example, the process of block 716 is pushed to the background for uninterrupted listing creation while the user 130 can focus solely on taking photos. The grouping of the photos in this example is configurable, for instance, 10 photos per listing, with an option to move to the next listing if user 130 determines that for that specific listing, a lesser number of images is sufficient. For example, 8 images are sufficient even though the continuous listing module 418 is configured for 10 images per listing.

In another example, if the system detects any errors in the initial pictures, an AI analysis is sent to user 130. This will allow user 130 to retake the photos if necessary or to create a new listing and delete the entire photo sequence for the previous listing.

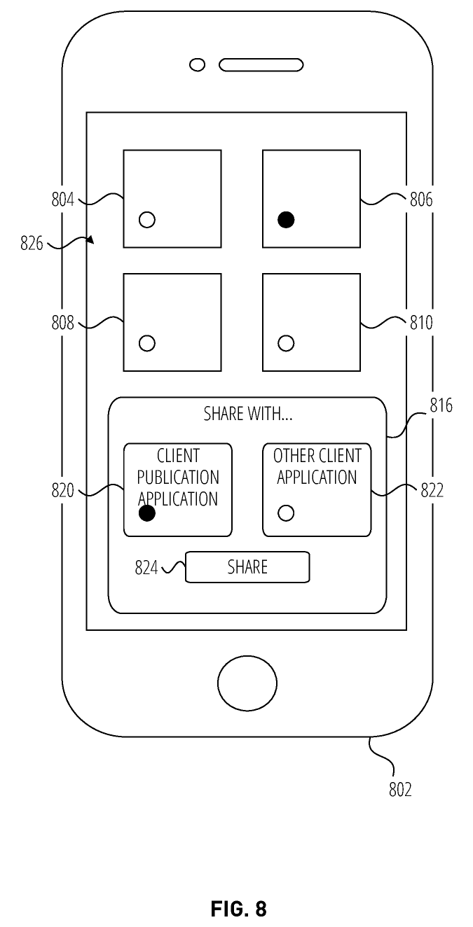

FIG. 8 illustrates a graphical user interface of a native photo application in accordance with one example embodiment. The mobile device 802 displays a photo album 826 using the native imaging application 132. For example, the photo album 826 displays photo 804, photo 806, photo 808, and photo 810. FIG. 8 illustrates that the photo 806 is selected. The native photo application also displays a sharing user interface 816. The selected image (e.g., photo 806) can be shared with client publication application 820 and/or other client application 822. FIG. 8 illustrates a selection of the client publication application 820. The photo 806 is shared with client publication application 820 once the user of the mobile device 802 taps on the share button 824.

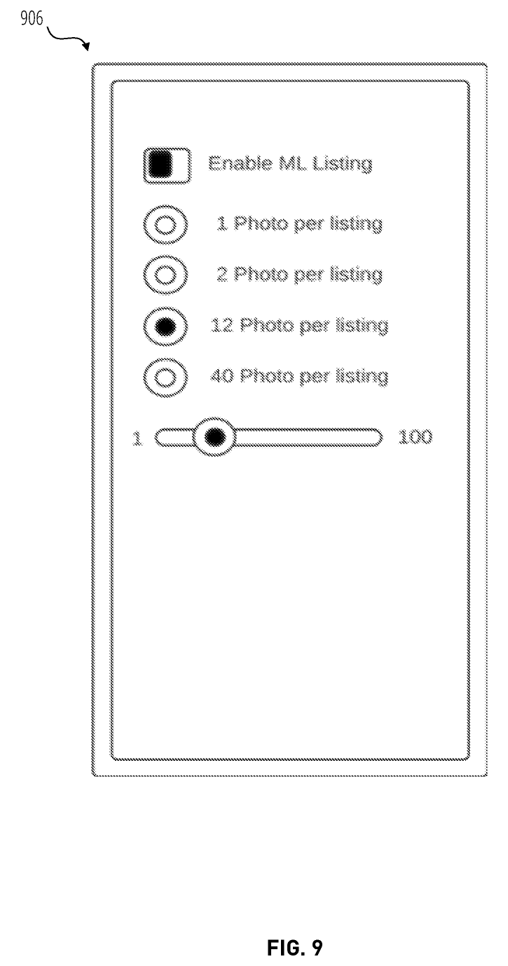

FIG. 9 illustrates a photo group graphical user interface 906 in accordance with one example embodiment. The photo group graphical user interface 906 enables a user to select how many photos to include per listing.

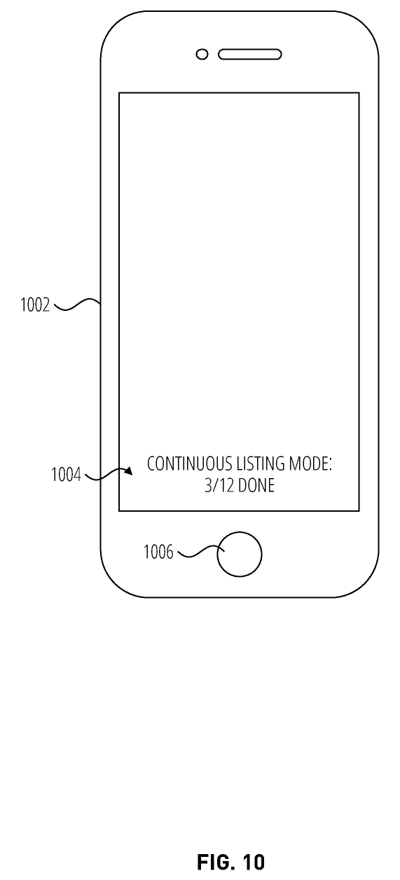

FIG. 10 illustrates a graphical user interface of a continuous listing mode in accordance with one example embodiment. The mobile device 1002 indicates a continuous listing mode indicator 1004 while the user takes pictures using the camera button 1006.

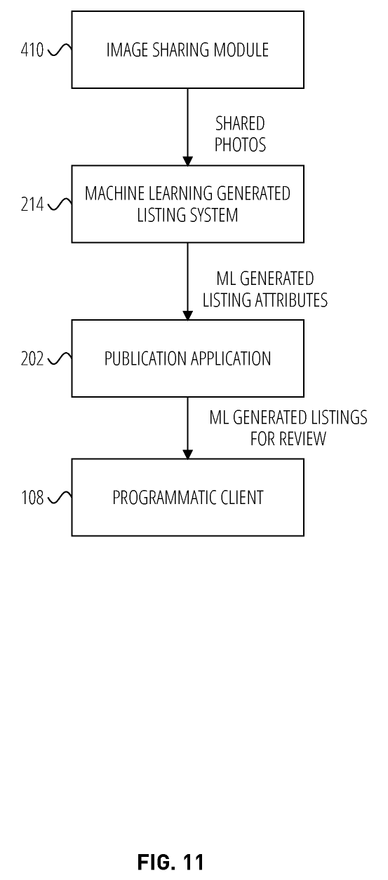

FIG. 11 illustrates a flow process in accordance with one example embodiment. The image sharing module 410 provides shared photos to the machine learning generated listing system 214. The machine learning generated listing system 214 using ML to identify characteristics of the item depicted in the shared photos. The machine learning generated listing system 214 sends the ML generated listing attributes (based on the identified characteristics) to the publication application 202. The publication application 202 generates a daft listing to the programmatic client 108 for review.

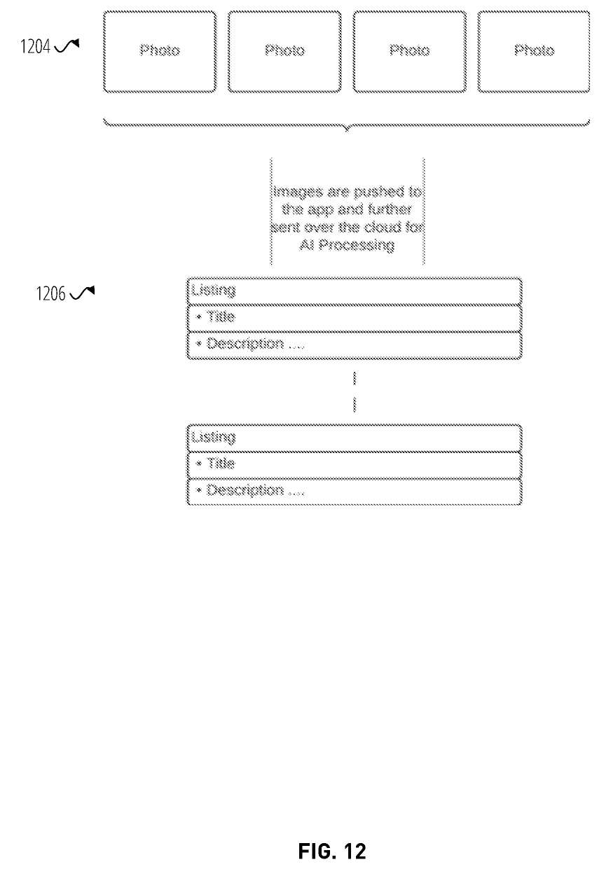

FIG. 12 illustrates a flow process for a machine learning generated listing in accordance with one example embodiment. The shared photos 1204 are processed using ML to generate ML generated listings 1206.

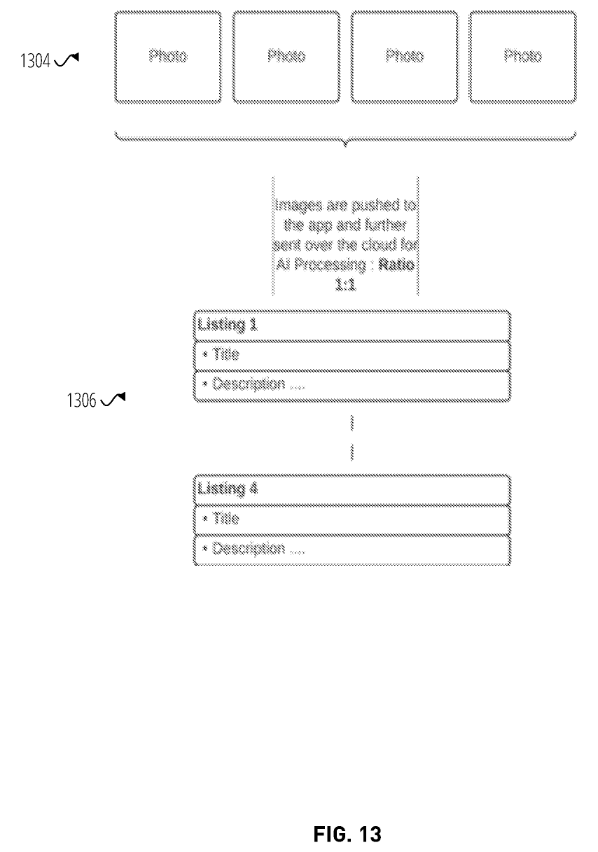

FIG. 13 illustrates a flow process for a machine learning generated listing with a group ratio in accordance with one example embodiment. The shared photos 1304 are processed using ML to generate ML generated listings 1306 based on a group setting (e.g., 1 picture per listing).

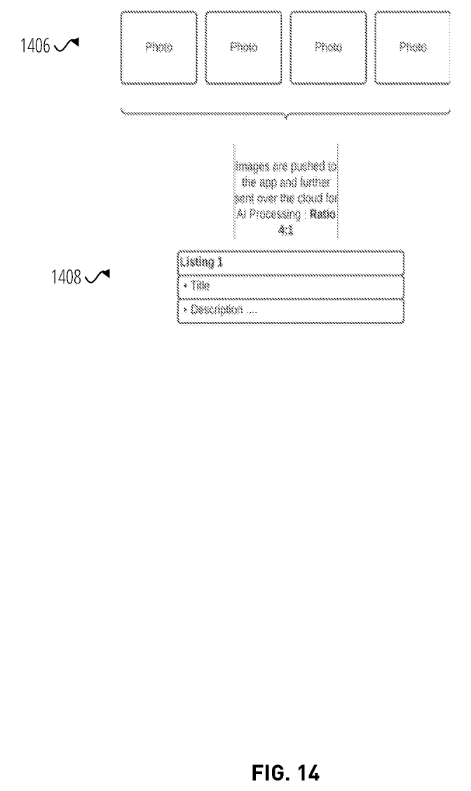

FIG. 14 illustrates a flow process for a machine learning generated listing with a group ratio in accordance with another example embodiment. The shared photos 1406 are processed using ML to generate ML generated listing 1408 based on a group setting (e.g., 4 pictures per listing).

FIG. 15 is a diagrammatic representation of the machine 1500 within which instructions 1508 (e.g., software, a program, an application, an applet, an app, or other executable code) for causing the machine 1500 to perform any one or more of the methodologies discussed herein may be executed. For example, the instructions 1508 may cause the machine 1500 to execute any one or more of the methods described herein. The instructions 1508 transform the general, non-programmed machine 1500 into a particular machine 1500 programmed to carry out the described and illustrated functions in the manner described. The machine 1500 may operate as a standalone device or may be coupled (e.g., networked) to other machines. In a networked deployment, the machine 1500 may operate in the capacity of a server machine or a client machine in a server-client network environment, or as a peer machine in a peer-to-peer (or distributed) network environment. The machine 1500 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1508, sequentially or otherwise, that specify actions to be taken by the machine 1500. Further, while only a single machine 1500 is illustrated, the term “machine” shall also be taken to include a collection of machines that individually or jointly execute the instructions 1508 to perform any one or more of the methodologies discussed herein.

The machine 1500 may include processors 1502, memory 1504, and I/O components 1542, which may be configured to communicate with each other via a bus 1544. In an example embodiment, the processors 1502 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1506 and a processor 1510 that execute the instructions 1508. The term “processor” is intended to include multi-core processors that may comprise two or more independent processors (sometimes referred to as “cores”) that may execute instructions contemporaneously. Although FIG. 15 shows multiple processors 1502, the machine 1500 may include a single processor with a single core, a single processor with multiple cores (e.g., a multi-core processor), multiple processors with a single core, multiple processors with multiples cores, or any combination thereof.

The memory 1504 includes a main memory 1512, a static memory 1514, and a storage unit 1516, both accessible to the processors 1502 via the bus 1544. The main memory 1504, the static memory 1514, and storage unit 1516 store the instructions 1508 embodying any one or more of the methodologies or functions described herein. The instructions 1508 may also reside, completely or partially, within the main memory 1512, within the static memory 1514, within machine-readable medium 1518 within the storage unit 1516, within at least one of the processors 1502 (e.g., within the processor’s cache memory), or any suitable combination thereof, during execution thereof by the machine 1500.

The I/O components 1542 may include a wide variety of components to receive input, provide output, produce output, transmit information, exchange information, capture measurements, and so on. The specific I/O components 1542 that are included in a particular machine will depend on the type of machine. For example, portable machines such as mobile phones may include a touch input device or other such input mechanisms, while a headless server machine will likely not include such a touch input device. It will be appreciated that the I/O components 1542 may include many other components that are not shown in FIG. 15. In various example embodiments, the I/O components 1542 may include output components 1528 and input components 1530. The output components 1528 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1530 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1542 may include biometric components 1532, motion components 1534, environmental components 1536, or position components 1538, among a wide array of other components. For example, the biometric components 1532 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1534 include acceleration sensor components (e.g., accelerometer), gravitation sensor components, rotation sensor components (e.g., gyroscope), and so forth. The environmental components 1536 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1538 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1542 further include communication components 1540 operable to couple the machine 1500 to a network 1520 or devices 1522 via a coupling 1524 and a coupling 1526, respectively. For example, the communication components 1540 may include a network interface component or another suitable device to interface with the network 1520. In further examples, the communication components 1540 may include wired communication components, wireless communication components, cellular communication components, Near Field Communication (NFC) components, Bluetooth^{®} components (e.g., Bluetooth^{®} Low Energy), Wi-Fi^{®} components, and other communication components to provide communication via other modalities. The devices 1522 may be another machine or any of a wide variety of peripheral devices (e.g., a peripheral device coupled via a USB).

Moreover, the communication components 1540 may detect identifiers or include components operable to detect identifiers. For example, the communication components 1540 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1540, such as location via Internet Protocol (IP) geolocation, location via Wi-Fi® signal triangulation, location via detecting an NFC beacon signal that may indicate a particular location, and so forth.

The various memories (e.g., memory 1504, main memory 1512, static memory 1514, and/or memory of the processors 1502) and/or storage unit 1516 may store one or more sets of instructions and data structures (e.g., software) embodying or used by any one or more of the methodologies or functions described herein. These instructions (e.g., the instructions 1508), when executed by processors 1502, cause various operations to implement the disclosed embodiments.

The instructions 1508 may be transmitted or received over the network 1520, using a transmission medium, via a network interface device (e.g., a network interface component included in the communication components 1540) and using any one of a number of well-known transfer protocols (e.g., hypertext transfer protocol (HTTP)). Similarly, the instructions 1508 may be transmitted or received using a transmission medium via the coupling 1526 (e.g., a peer-to-peer coupling) to the devices 1522.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term "invention" merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method comprising:
detecting, at a photo application native to an operating system of a mobile device, a selection of one or more images generated with a camera of the mobile device;
detecting a selection of a client publication application installed on the mobile device using a user interface of the photo application;
in response to detecting the selection of the client publication application, identifying characteristics of an item depicted in the one or more images; and
generating one or more listings based on the characteristics of the item depicted in the one or more images.

2. The computer-implemented method of claim 1, further comprising:
detecting a user request to share the selection of the one or more images in the user interface of the photo application; and
in response to detecting the user request to share the selection of the one or more images, presenting one or more client applications installed on the mobile device in the user interface of the photo application, the one or more client applications comprising the client publication application.

3. The computer-implemented method of claim 1, wherein identifying the characteristics of the item comprises:
applying, at the mobile device, a machine learning model to the one or more images to identify the characteristics of the item.

4. The computer-implemented method of claim 1, wherein identifying characteristics of the item comprises:
applying, at a server, a machine learning model to the one or more images to identify the characteristics of the item.

5. The computer-implemented method of claim 1, wherein generating the one or more listings comprising:
generating listing data based on the identified characteristics;
automatically populating fields of an online listing draft of the client publication application with the listing data, wherein the fields include at least a title and a description of the item; and
displaying the online listing draft at the mobile device using the client publication application.

6. The computer-implemented method of claim 1, wherein generating the one or more listings comprising:
generating listing data based on the identified characteristics;
automatically populating fields of an online listing draft of a server publication application with the listing data, wherein the fields include at least a title and a description of the item; and
providing the online listing draft from the server publication application to the client publication application.

7. The computer-implemented method of claim 1, further comprising:
identifying a group listing setting in the client publication application, the group listing setting indicating a number of images per listing, wherein each group of a plurality of groups of images comprises the number of images; and
generating a plurality of listings for the plurality of groups of images based on the number of images per listing, wherein each listing of the plurality of listings corresponds to an item depicted in a corresponding group of images from the one or more images.

8. The computer-implemented method of claim 1, further comprising:
identifying a continuous listing setting in the client publication application, the continuous listing setting indicating a default number of images per listing;
accessing continuously captured images with the client publication application;
segmenting the continuously captured images to group images corresponding to individual items depicted in the continuously captured images based on the default number of images per listing; and
generating separate listing drafts for each group of images corresponding to different items, wherein each listing draft is populated with listing data generated based on the characteristics identified from the respective group of images.

9. The computer-implemented method of claim 8, further comprising:
generating a first listing corresponding to a first item depicted in a first group of images of the one or more images, the first group of images comprising the default number of images; and
generating a second listing corresponding to a second item depicted in a second group of images of the one or more images, the first group of images comprising the default number of images.

10. The computer-implemented method of claim 1, further comprising:
identifying a continuous listing setting in the client publication application, the continuous listing setting indicating a preset number of images per listing;
continuously capturing a plurality of images using the client publication application;
displaying an image counter in the client publication application, the image counter indicating a number of images being captured after launching an image capture operation using the client publication application;
detecting, with the image counter in the client publication application, that the number of captured images has reached the preset number of images per listing; and
in response to detecting that the number of captured images has reached the preset number of images per listing, generating a first listing for the preset number of images and resetting the image counter in the client publication application.

11. A computing apparatus comprising:
a processor; and
a memory storing instructions that, when executed by the processor, configure the apparatus to:
detect, at a photo application native to an operating system of a mobile device, a selection of one or more images generated with a camera of the mobile device;
detect a selection of a client publication application installed on the mobile device using a user interface of the photo application;
in response to detecting the selection of the client publication application, identify characteristics of an item depicted in the one or more images; and
generate one or more listings based on the characteristics of the item depicted in the one or more images.

12. The computing apparatus of claim 11, wherein the instructions further configure the apparatus to:
detect a user request to share the selection of the one or more images in the user interface of the photo application; and
in response to detecting the user request to share the selection of the one or more images, present one or more client applications installed on the mobile device in the user interface of the photo application, the one or more client applications comprising the client publication application.

13. The computing apparatus of claim 11, wherein identifying the characteristics of the item comprises:
apply, at the mobile device, a machine learning model to the one or more images to identify the characteristics of the item.

14. The computing apparatus of claim 11, wherein identifying characteristics of the item comprises:
apply, at a server, a machine learning model to the one or more images to identify the characteristics of the item.

15. The computing apparatus of claim 11, wherein generating the one or more listings comprising:
generate listing data based on the identified characteristics;
automatically populate fields of an online listing draft of the client publication application with the listing data, wherein the fields include at least a title and a description of the item; and
display the online listing draft at the mobile device using the client publication application.

16. The computing apparatus of claim 11, wherein generating the one or more listings comprising:
generate listing data based on the identified characteristics;
automatically populate fields of an online listing draft of a server publication application with the listing data, wherein the fields include at least a title and a description of the item; and
provide the online listing draft from the server publication application to the client publication application.

17. The computing apparatus of claim 11, wherein the instructions further configure the apparatus to:
identify a group listing setting in the client publication application, the group listing setting indicating a number of images per listing, wherein each group of a plurality of groups of images comprises the number of images; and
generate a plurality of listings for the plurality of groups of images based on the number of images per listing, wherein each listing of the plurality of listings corresponds to an item depicted in a corresponding group of images from the one or more images.

18. The computing apparatus of claim 11, wherein the instructions further configure the apparatus to:
identify a continuous listing setting in the client publication application, the continuous listing setting indicating a default number of images per listing;
access continuously captured images with the client publication application;
segment the continuously captured images to group images corresponding to individual items depicted in the continuously captured images based on the default number of images per listing; and
generate separate listing drafts for each group of images corresponding to different items, wherein each listing draft is populated with listing data generated based on the characteristics identified from the respective group of images.

19. The computing apparatus of claim 18, wherein the instructions further configure the apparatus to:
generate a first listing corresponding to a first item depicted in a first group of images of the one or more images, the first group of images comprising the default number of images; and
generate a second listing corresponding to a second item depicted in a second group of images of the one or more images, the first group of images comprising the default number of images.

20. A non-transitory computer-readable storage medium, the computer-readable storage medium including instructions that when executed by a computer, cause the computer to:
detect, at a photo application native to an operating system of a mobile device, a selection of one or more images generated with a camera of the mobile device;
detect a selection of a client publication application installed on the mobile device using a user interface of the photo application;
in response to detecting the selection of the client publication application, identify characteristics of an item depicted in the one or more images; and
generate one or more listings based on the characteristics of the item depicted in the one or more images.
